(19) United States
(12) Patent Application Publication
(10) Pub. No.: US 2023/0415105 A1
(43) Pub. Date: Dec. 28, 2023

(54) SLIT CHAMBER AND ATOMIZING APPARATUS

(71) Applicant: SUGINO MACHINE LIMITED, Namerikawa City (JP)

(72) Inventors: Seigo MURAYAMA, Namerikawa City (JP); Sho Sato, Namerikawa City (JP); Futoshi HIMI, Namerikawa City (JP)

(21) Appl. No.: 18/310,910

(22) Filed: May 2, 2023

(30) Foreign Application Priority Data
Jun. 24, 2022 (JP) 2022-102093

(51) Int. Cl. B01F 23/213; B05B 1/04

(52) U.S. Cl. CPC B01F 23/21321; B05B 1/044

(57) ABSTRACT

Provided is an atomizing apparatus that reduces stress concentration applied to a slit chamber, maintains an appropriate tightening force, and improves maintenance performance. The slit chamber includes: a water guide nozzle into which raw material is supplied; an upstream nozzle disposed on a downstream side of the water guide nozzle, the upstream nozzle including a first and a second upstream nozzle water guide portions each having an elongated hole and having enlarged diameter portions at both ends; and a downstream nozzle disposed on a downstream side of the upstream nozzle, the downstream nozzle having a downstream nozzle water guide portion into which the raw material is supplied.

### CROSS-REFERENCE TO RELATED APPLICATIONS

This application claims the benefit of priority to Japanese Patent Application No. 2022-102093, filed on Jun. 24, 2022, the entire contents of which are hereby incorporated by reference.

### BACKGROUND

### 1. Technical Field

The present invention relates to a slit chamber and an atomizing apparatus for atomizing a raw material slurry.

### 2. Description of the Background

Conventionally, a ball mill, a colloid mill, a disperser, a homogenizer, and the like have been used as an atomizing apparatus.

In order to adjust the characteristics of the raw material and the performance to be imparted, the atomizing apparatus includes a chamber having a nozzle. Nozzle and liner structures called slit chambers are disclosed.

For example, in the emulsifying apparatus disclosed in Japanese Patent No. 2788010 and JP H05-012976 B, the flow path is closed by two liner members made of a hard plate material. In the first liner member disposed on the inflow side, two first through holes are formed at the target position with respect to the center of the plate surface. Each liquid mixture ejected from the nozzle can pass through two first through holes. On one plate surface of the first liner member, a groove portion for communicating the end portion of the through hole is formed. The second liner member is disposed on the outflow side in close contact with the first liner member. A second groove portion orthogonal to the first groove portion is formed on the contact facing surface to the first liner member. Two second through holes for discharging are formed through both outer ends of the second groove portion. Emulsification is performed while the mixture passes through the first and second liner members.

Japanese patent publication No. JP 2022-63686 A discloses a slit chamber. For a plurality of nozzles constituting the slit chamber, holes, grooves, and the like formed in the upstream nozzle and the downstream nozzle are devised so as not to concentrate stress in a specific portion.

Also, Japanese Patent No. 6125433 discloses a chamber structure in which the inlet mixing chamber element 112 and the outlet mixing chamber element 114 are compressed between the inlet fixture 108 and the outlet fixture 110 by bolt fastening forces.

### BRIEF SUMMARY

In the conventional emulsifying apparatus, the first and second liner members are formed with through holes and guide grooves. However, when the mixed liquid (hereinafter, referred to as a raw material slurry) collides with or passes through the inner surface or the end surface of the liner member, the through hole and the guide groove, fracture may occur from a portion where a structurally weak portion or stress is concentrated.

In order to increase the processing amount, it is necessary to increase the number of holes and grooves, or to increase the flow path. However, since the thin nozzle member is processed, a long-life nozzle is required in consideration of avoiding stress concentration.

In order to realize a large flow rate by increasing the number of holes and grooves or increasing the flow path, so as not to damage the plurality of liner members or nozzles, in which hole, groove or the like is formed, an appropriate tightening force is to be applied to the appropriate position of the plurality of liner members or nozzles. Therefore, it is necessary to improve the tightening mechanism.

Since the thickness of the nozzle member is small, when the nozzle member is tightened only by the fastening force of the bolt, a structure that avoids damage due to excessive tightening to the nozzle member having a small thickness is required.

An object of the present invention is to provide a slit chamber and an atomizing apparatus that reduce stress concentration applied to the slit chamber, maintain an appropriate tightening force, and improve maintenance performance.

A first aspect of the present invention provides a slit chamber, including:
a water guide nozzle into which raw material is supplied;
an upstream nozzle disposed on a downstream side of the water guide nozzle, the upstream nozzle including a first and a second upstream nozzle water guide portions each having an elongated hole and having enlarged diameter portions at both ends; and
a downstream nozzle disposed on a downstream side of the upstream nozzle, the downstream nozzle having a downstream nozzle water guide portion into which the raw material is supplied.

A second aspect of the present invention provides an atomizing apparatus, including:
a raw material tank configured to store the raw material;
a liquid supply pump configured to pump the raw material from the raw material tank;
a pressure intensifier configured to pressurize the raw material supplied from the liquid supply pump; and
the slit chamber.

According to the present invention, it is possible to provide a slit chamber and an atomizing apparatus that reduce stress concentration applied to the slit chamber, maintain an appropriate tightening force, and improve maintenance performance.

### BRIEF DESCRIPTION OF DRAWINGS

FIG. 1 is a sectional view of a slit chamber according to an embodiment.

FIG. 2A is a front view of an upstream nozzle.

FIG. 2B is a front view of a downstream nozzle.

FIG. 2C is a front view of a load receiving nozzle.

FIG. 3 is an enlarged sectional view of a main part of the slit chamber according to the embodiment.

FIG. 4 is a sectional view of a modification of a water guide nozzle according to the embodiment.

FIG. 5 is a sectional view of a slit chamber according to a modification example.

FIG. 6 is a configuration diagram of an atomizing apparatus according to the embodiment.

### DETAILED DESCRIPTION

### Embodiment

Hereinafter, embodiments will be described with reference to the drawings as appropriate.

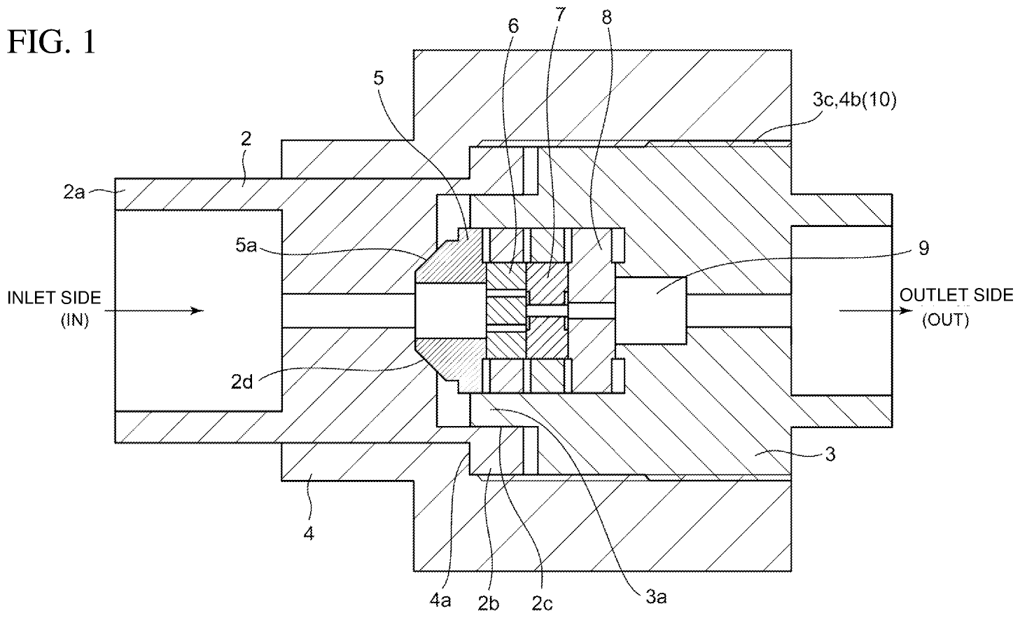

A slit chamber 1 according to the present embodiment atomizes the pressurized slurry-like raw material M. As shown in FIG. 1, in the slit chamber 1, the slurry-like raw material M is supplied from an inlet side (IN) toward an outlet side (OUT). The slit chamber 1 has a first chamber inner member 2, a second chamber inner member 3, and a chamber outer member 4. The second chamber inner member 3 is connected to the first chamber inner member 2. The chamber outer member 4 is disposed outside the first chamber inner member 2 and the second chamber inner member 3.

A water guide nozzle 5, an upstream nozzle 6, a downstream nozzle 7, a load receiving nozzle 8, a liquid merging port 9, and a tightening adjustment member 10 are arranged inside the second chamber inner member 3. The water guide nozzle 5 is joined to the first chamber inner member 2. The upstream nozzle 6 is disposed on the downstream side of the water guide nozzle 5. The downstream nozzle 7 is disposed on the downstream side of the upstream nozzle 6. The load receiving nozzle 8 is disposed on the downstream side of the downstream nozzle 7. The tightening adjustment member adjusts the tightening of the first chamber inner member 2, the second chamber inner member 3, and the chamber outer member 4.

The slurry-like raw material M pressurized by a pressure intensifier 103 is introduced into the first chamber inner member 2. The first chamber inner member 2 has a cylindrical first distal end 2a formed on the upstream side. By the first distal end 2a disposed or connected to a portion of the atomizing apparatus 100, a high-pressure pipe or a high-pressure hose allows the slurry-like raw material M to be taken in through the first distal end 2a.

It should be noted that the first distal end 2a may be shaped so as to be easily connected to a part of the atomizing apparatus 100. The first distal end 2a is, for example, cylindrical or polygonal. A single-touch fastener may be disposed to facilitate coupling the first distal end 2a to a portion of the atomizing apparatus 100.

The first chamber inner member 2 has a recess 2c and a peripheral portion 2b. The recess 2c, which is cylindrical, is formed on the downstream side. The peripheral portion 2b is disposed on the outer side of the recess 2c. The chamber outer member 4 has an engagement portion 4a on the inner side. The peripheral portion 2b engages with the engagement portion 4a. Thus, a reference plane for positioning the first chamber inner member 2, the various nozzles (the water guide nozzle 5, the upstream nozzle 6, the downstream nozzle 7, and the load receiving nozzle 8), and the second chamber inner member 3 is set.

The recess 2c has a depth sufficient to allow the water guide nozzle 5 to be installed therein. The second chamber inner member 3 has a second distal end 3a. The recess 2c may have any strength or structural stability while the second distal end 3a is provided therein.

The peripheral portion 2b may stably engage the first chamber inner member 2 and the chamber outer member 4. The peripheral portion 2b and the engagement portion 4a may be formed of a rigid or hard material. The peripheral portion 2b and the engagement portion 4a may be coated with a highly rigid or hard material. The peripheral portion 2b and the engagement portion 4a have widths and sizes that can be engaged with each other. The first chamber inner member 2 and the chamber outer member 4 may be engaged with each other via a resin component.

The second chamber inner member 3 is connected to the first chamber inner member 2. Various nozzles (the water guide nozzle 5, the upstream nozzle 6, the downstream nozzle 7, and the load receiving nozzle 8) are disposed inside the second chamber inner member 3.

The second chamber inner member 3 has the second distal end 3a. The second distal end 3a, which is cylindrical, is formed on the upstream side. The second distal end 3a is joined to the recess 2c of the first chamber inner member 2. As a result, the slurry-like raw material M is supplied from the flow path formed in the first chamber inner member 2 to the various nozzles (the water guide nozzle 5, the upstream nozzle 6, the downstream nozzle 7, and the load receiving nozzle 8).

The first chamber inner member 2 and the second chamber inner member 3 are disposed inside the chamber outer member 4. The chamber outer member 4 fixes the positions of the first chamber inner member 2 and the second chamber inner member 3. By applying a tightening force to the entire chamber, the position of the flow path through which the slurry-like raw material M passes is stabilized.

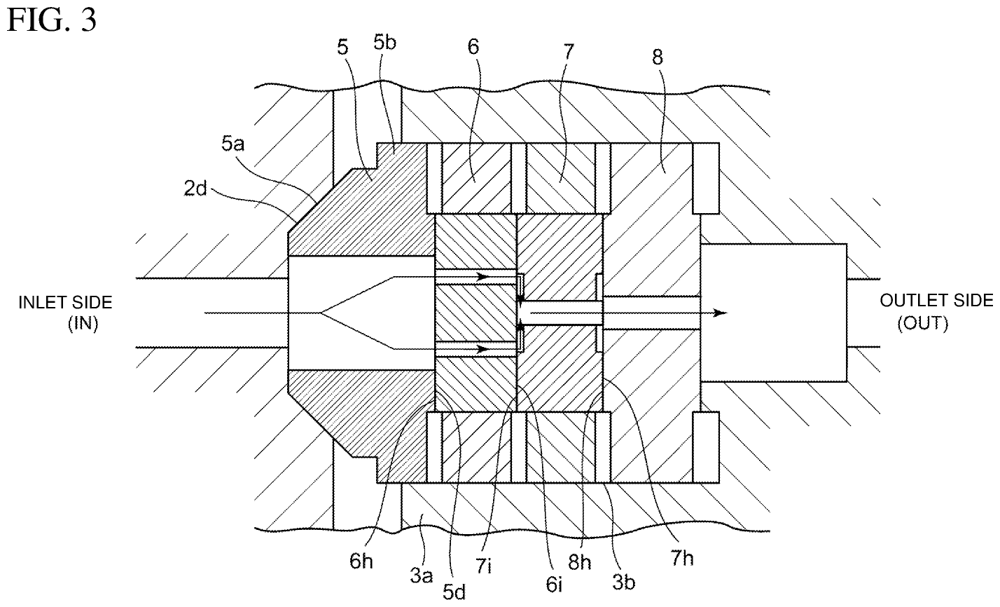

As shown in FIGS. 1 and 3, the water guide nozzle 5 adjusts the tightening positions of the first chamber inner member 2 and the second chamber inner member 3 in a state where the positions of the various nozzles (the upstream nozzle 6, the downstream nozzle 7, and the load receiving nozzle 8) are stabilized. As shown in FIG. 3, the water guide nozzle 5 has a water guide nozzle taper 5a on the upstream side. The first chamber inner member 2 has a first chamber inner member slope 2d on the downstream side. The water guide nozzle taper 5a and the first chamber inner member slope 2d are arranged in a proper surface contact.

As shown in FIG. 3, the water guide nozzle 5 has a water guide nozzle peripheral portion 5b on an outer periphery of a downstream side. The water guide nozzle peripheral portion 5b has an outer diameter that is greater than or equal to an inner diameter of the second distal end 3a. This prevents blur in the entire circumferential direction. The water guide nozzle peripheral portion 5b may be coated or the like to prevent damages or the like.

As a modification, the water guide nozzle 5 may be divided into a water guide nozzle inner member and a water guide nozzle outer member. The water guide nozzle inner member (not shown) is disposed inside the water guide nozzle outer member (not shown). The water guide nozzle inner member is made of a material having a hardness higher than that of the water guide nozzle outer member in order to withstand the raw material process.

The water guide nozzle 5 has a flow path that communicates with a first upstream nozzle water guide portion 6c and a second upstream nozzle water guide portion 6e on the inside thereof. The flow path may be set such as a straight shape and a reduced diameter shape in accordance with the shape of the flow path of the nozzle disposed on the downstream side and the amount of the raw material M to be passed.

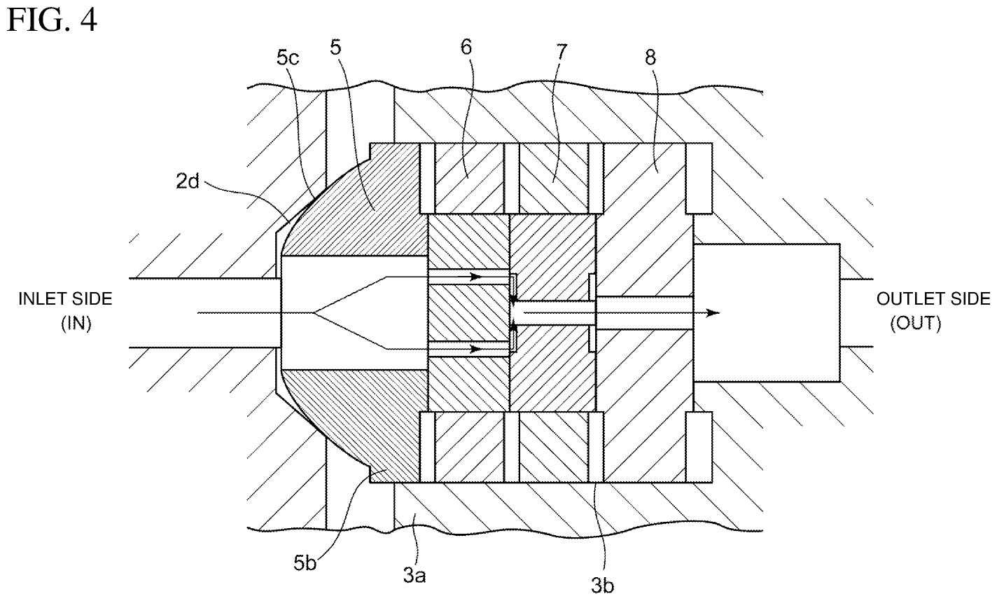

FIG. 4 shows a modification of the water guide nozzle 5. The water guide nozzle 5 has a water guide nozzle arc portion 5c instead of the water guide nozzle taper 5a. The water guide nozzle arc portion 5c has an arcuate surface. Therefore, the water guide nozzle arc portion 5c contacts the first chamber inner member slope 2d in a point or arc shape. This allows to avoid galling or damage to other elements as compared to the case of surface contact. The angle of the arc in the water guide nozzle arc portion 5c is appropriately set in accordance with the angle of the first chamber inner member slope 2d.

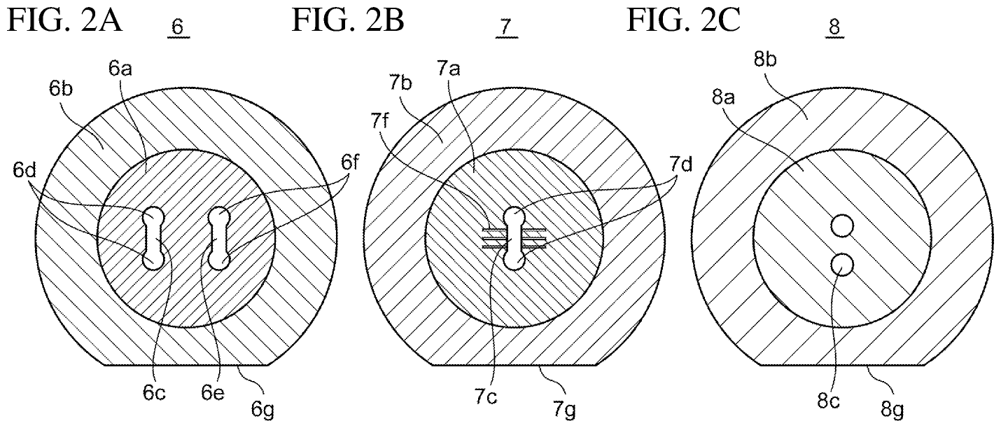

As shown in FIGS. 1 and 2A, the upstream nozzle 6 is disposed inside the second chamber inner member 3 and on the downstream side of the water guide nozzle 5. The upstream nozzle 6 includes an upstream nozzle inner member 6a and an upstream nozzle outer member 6b. The upstream nozzle inner member 6a is disposed inside the upstream nozzle outer member 6b. The upstream nozzle inner member 6a is formed of a material that is harder than the upstream nozzle outer member 6b in order to withstand the raw material process.

The upstream nozzle inner member 6a includes a first upstream nozzle water guide portion 6c and a second upstream nozzle water guide portion 6e. First upstream nozzle enlarged diameter portions 6d are formed at both ends of the first upstream nozzle water guide portion 6c. Second upstream nozzle enlarged diameter portions 6f are formed at both ends of the second upstream nozzle water guide portion 6e. In order to increase the processing amount of the raw material M, a large amount of the raw material M is to be taken into the chamber. It is not possible to sufficiently process the raw material M only by forming the first and second upstream nozzle water guide portions 6c, 6e into a circular shape or an elliptical shape. When the first and second upstream nozzle water guide portions 6c, 6e are formed in an elongated hole shape (a vertically elongated shape), stresses are concentrated at both end portions of the first and second upstream nozzle water guide portions 6c, 6e, and the upstream nozzle 6 is likely to be damaged. By forming the first upstream nozzle enlarged diameter portions 6d and the second upstream nozzle enlarged diameter portions 6f at both ends of the first and second upstream nozzle water guide portions 6c, 6e, respectively, it is possible to reduce the stress concentration of the upstream nozzle 6 and to achieve a long life.

The first and second upstream nozzle water guide portions 6c, 6e may have an elongated hole shape (a vertically elongated shape), and the height, the width, and the number thereof may be appropriately set. The first upstream nozzle enlarged diameter portion 6d and the second upstream nozzle enlarged diameter portion 6f may have shapes larger in width (inner diameter and outer diameter) than the first and second upstream nozzle water guide portions 6c, 6e. As shown in FIG. 2A, the shape of the first upstream nozzle enlarged diameter portion 6d and the shape of the second upstream nozzle enlarged diameter portion 6f are preferably circular, but may be a shape in which stress concentration can be avoided separately. The number of nozzle enlarged diameter portion increases according to the number of the upstream nozzle water guide portions. By coating or the like on the first and second upstream nozzle water guide portions 6c, 6e, damages or the like can be prevented.

As shown in FIGS. 1 and 2B, the downstream nozzle 7 is disposed inside the second chamber inner member 3 and on the downstream side of the upstream nozzle 6. The downstream nozzle 7 includes a downstream nozzle inner member 7a and a downstream nozzle outer member 7b. The downstream nozzle inner member 7a is disposed inside the downstream nozzle outer member 7b. The downstream nozzle inner member 7a is formed of a material that is harder than the downstream nozzle outer member 7b in order to withstand the raw material process.

The downstream nozzle inner member 7a includes a downstream nozzle water guide portion 7c. Downstream nozzle enlarged diameter portions 7d are formed at both ends of the downstream nozzle water guide portion 7c. Similar to the first upstream nozzle enlarged diameter portion 6d and the second upstream nozzle enlarged diameter portion 6f, the downstream nozzle enlarged diameter portion 7d can avoid stress concentration occurring when the flow rate of the raw material M is increased, and can realize a longer life of the downstream nozzle 7.

The downstream nozzle water guide portion 7c may have an elongated hole shape (a vertically elongated shape), and the height and the width thereof may be appropriately set. The downstream nozzle enlarged diameter portion 7d may be formed to have a larger width (inner diameter or outer diameter) than the downstream nozzle water guide portion 7c. As shown in FIG. 2B, the downstream nozzle enlarged diameter portion 7d preferably has a circular shape, but may have any shape in which stress concentration can be avoided and countermeasures are taken. The number of nozzle enlarged diameter portions increases according to the number of downstream nozzle water guide portions. By applying a coating or the like to the downstream nozzle enlarged diameter portion 7d, damages or the like can be prevented.

As shown in FIGS. 1 and 2C, the load receiving nozzle 8 is disposed on the downstream side of the downstream nozzle 7. The load receiving nozzle 8 has a load receiving nozzle water guide portion 8c. The load receiving nozzle 8 is disposed so that the downstream nozzle water guide portion 7c and the load receiving nozzle water guide portion 8c communicate with each other. The load receiving nozzle 8 includes a load receiving nozzle inner member 8a and a load receiving nozzle outer member 8b. The load receiving nozzle inner member 8a is disposed inside the load receiving nozzle outer member 8b. The load receiving nozzle inner member 8a is formed of a material that is harder than the load receiving nozzle outer member 8b in order to withstand the material process.

The load receiving nozzle water guide portion 8c has a size equal to or larger than the size of the downstream nozzle enlarged diameter portion 7d. Applying a coating or the like to the load receiving nozzle water guide portion 8c prevents damages and the like.

As a modification, the load receiving nozzle 8 may have an integrated structure without forming the load receiving nozzle inner member 8a and the load receiving nozzle outer member 8b into a divided structure. Suitable one is selected in accordance with material and shape of the upstream nozzle 6 and the downstream nozzle 7.

The materials of the water guide nozzle 5, the upstream nozzle 6, the downstream nozzle 7, and the load receiving nozzle 8 are desirably high hardness materials such as various metals, carbide, and sintered diamond.

The water guide nozzle 5, the upstream nozzle 6, the downstream nozzle 7, and the load receiving nozzle 8 each have a joint portion and have a structure of being joined to each other.

The water guide nozzle 5 has a projection-shaped water guide nozzle joint 5d. The water guide nozzle joint 5d is formed on the downstream side of the water guide nozzle taper 5a. The upstream nozzle 6 has a projection-shaped first upstream nozzle joint 6h. The first upstream nozzle joint 6h is formed on the upstream side of the upstream nozzle inner member 6a. The water guide nozzle joint 5d and the first upstream nozzle joint 6h are joined.

The upstream nozzle 6 has a projection-shaped second upstream nozzle joint 6i. The second upstream nozzle joint 6i is formed on the downstream side of the upstream nozzle inner member 6a. The downstream nozzle 7 has a projection-shaped first downstream nozzle joint 7i. The first downstream nozzle joint 7i is formed on the upstream side of the downstream nozzle inner member 7a. The second upstream nozzle joint 6i and the first downstream nozzle joint 7i are joined.

The downstream nozzle 7 has a projection-shaped second downstream nozzle joint 7h. The second downstream nozzle joint 7h is formed on the downstream side of the downstream nozzle inner member 7a. The load receiving nozzle 8 has a projection-shaped load receiving nozzle joint 8h. The load receiving nozzle joint 8h is formed on the upstream side of the load receiving nozzle inner member 8a. The second downstream nozzle joint 7h and the load receiving nozzle joint 8h are joined.

In this way, by joining the joints in a flat state, it is possible to ensure an appropriate flow of the fluid (raw material M) in the nozzle. Each nozzle has an inner member and an outer member. In this manner, the structure is capable of fixing at least one of the inner member and the outer member as a shaft, whereby a stable structure is obtained. By applying a coating or the like to the joint portion, damage or the like can be prevented.

An upstream nozzle flat portion 6g is formed in a lower portion of the upstream nozzle outer member 6b. A downstream nozzle flat portion 7g is formed in a lower portion of the downstream nozzle outer member 7b. A load receiving nozzle flat portion 8g is formed in a lower portion of the load receiving nozzle outer member 8b.

A positioning flat portion 3b having a flat shape is formed inside the second chamber inner member 3. As a result, it is possible to perform appropriate positioning of the upstream nozzle flat portion 6g, the downstream nozzle flat portion 7g, and the load receiving nozzle flat portion 8g in accordance with the positioning flat portion 3b.

Note that the positioning structure based on the shape of the flat portion is an example, and can be appropriately set such as a groove mechanism or a screw mechanism of each element. In addition, a seal member may be disposed as appropriate.

Instead of or in addition to the flat portion, one or more connecting portions (not shown) may be disposed so that the flow paths passing through the water guide nozzle 5, the upstream nozzle 6, the downstream nozzle 7, and the load receiving nozzle 8 are appropriately joined to each other. For example, the connecting portion is connected by a fixing device or the like from the outside of each nozzle, or is connected by a fixing device or the like from the outer periphery of the water guide portion or the enlarged diameter portion (from the inside of each nozzle).

An atomization flow path 7f is perpendicular to the downstream nozzle water guide portion 7c. The atomization flow path 7f is in communication with the first and second upstream nozzle water guide portions 6c, 6e. The raw material M is atomized by the atomization flow path 7f. By forming the plurality of atomization flow paths 7f, the amount of the raw material to be subjected to the atomization process can be increased. The number of the atomization flow paths 7f may be changed in accordance with the height and width of the first and second upstream nozzle water guide portions 6c, 6e. The shape of the atomization flow path 7f may be any shape such as a cylindrical shape or a polygonal shape. The atomization flow path 7f preferably has a cylindrical shape.

As shown in FIG. 3, the atomization flow path 7f is formed not only on one surface but also on both surfaces of the downstream nozzle inner member 7a. In the initial arrangement, the raw material M is atomized in a first atomization flow path 7fa formed on the upstream side. Due to the atomization process, the inside of the first atomization flow path 7fa may be worn. The front and back sides of the downstream nozzle inner member 7a can be used in the event of a failure by forming a second atomization flow path 7fb on the other side of the downstream nozzle inner member 7a.

The width of the downstream nozzle water guide portion 7c in the left-right direction is smaller than the width of the atomization flow path 7f in the left-right direction. After the slurry-like raw material M that has passed through the first and second upstream nozzle water guide portions 6c, 6e collides with an inlet-side end face of the downstream nozzle 7, it moves in the right-angle direction. Then, the slurry-like raw material M is atomized by the reduced-diameter atomization flow path 7f.

When the atomizing apparatus 100 is activated, the flow of the slurry-like raw material M, which is temporarily filled in the inner space in the vicinity of the first and second upstream nozzle water guide portions 6c, 6e, is disturbed. However, as the processed material continues to be ejected from the merging port 9, the turbulence of the flow of the slurry-like raw material M is reduced.

The depth of the atomization flow path 7f is smaller than the depth of the downstream nozzle water guide portion 7c. The vertical width of the atomization flow path 7f is smaller than the diameters of the first and second upstream nozzle water guide portions 6c, 6e. Due to the reduction in diameter and the reduction in flow, a strong shear stress is applied to the raw material M, and the atomization performance is improved.

The downstream nozzle water guide portion 7c and the atomization flow path 7f may be subjected to a surface treatment, or the flow path may be formed into an uneven shape.

The tightening adjustment member 10 adjusts the tightening force of the first chamber inner member 2, the second chamber inner member 3, and the chamber outer member 4. For example, as shown in FIG. 1, the tightening adjustment member 10 includes a groove portion 3c and a threaded portion 4b. The groove portion 3c is formed on the outer side of the second chamber inner member 3. The threaded portion 4b is formed inside the chamber outer member 4.

In the case of only tightening using a fastener (not shown) such as a bolt, excessive tightening force may be applied due to an increase or decrease in force of an operator, and galling or damage may occur between the elements that come into contact with each other. Such a problem can be reduced by adopting a simple fastening structure instead of applying a personal fastening force.

### Modification

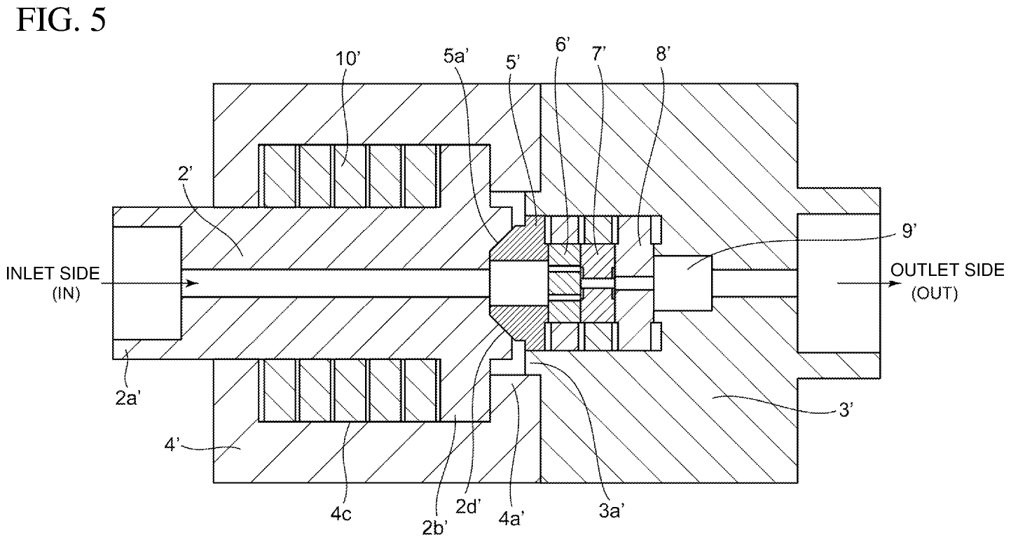

A slit chamber 1A of a modification atomizes the pressurized slurry-like raw material M. As shown in FIG. 5, the slurry-like raw material M is supplied from the inlet side (IN) toward the outlet side (OUT) in the slit chamber 1A. The slit chamber 1A has a first chamber inner member 2′, a second chamber inner member 3′, and a chamber outer member 4′. The second chamber inner member 3′ is connected to the first chamber inner member 2′. The chamber outer member 4′ is disposed outside the first chamber inner member 2′ and the second chamber inner member 3′.

A water guide nozzle 5′, an upstream nozzle 6′, a downstream nozzle 7′, a load receiving nozzle 8′, and a merging port 9′ are disposed inside the second chamber inner member 3′. The water guide nozzle 5′ is joined to the first chamber inner member 2′. The upstream nozzle 6′ is disposed on the downstream side of the water guide nozzle 5′. The downstream nozzle 7′ is disposed on the downstream side of the upstream nozzle 6′. The load receiving nozzle 8′ is disposed on the downstream side of the downstream nozzle 7′.

The chamber outer member 4′ has a recess 4c inside thereof. The tightening adjustment member 10′ is disposed in a space defined by the recess 4c and the exterior of the first chamber inner member 2′. A tightening adjustment member 10′ includes, for example, one or more elastic members such as a spring. Thus, an elastic force for avoiding excessive tightening can be added.

### Atomizing Apparatus

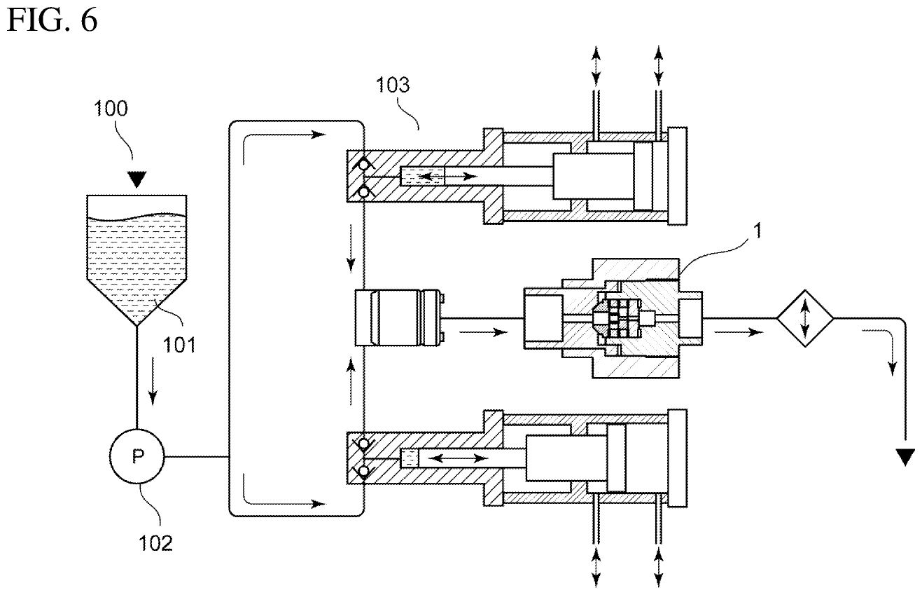

Referring to FIG. 6, an atomizing apparatus 100 according to the embodiment will be described. The atomizing apparatus 100 includes a raw material tank 101, a liquid supply pump 102, a pressure intensifier 103, and the slit chamber 1. The raw material tank 101 stores the slurry-like raw material M. The liquid supply pump 102 pumps the raw material slurry in the raw material tank 101. The pressure intensifier 103 pressurizes the slurry-like raw material M supplied from the liquid supply pump 102. The slit chamber 1 emulsifies the pressurized slurry-like raw material M.

Hereinafter, a processing procedure in the atomizing apparatus 100 according to the present embodiment will be described. Note that the slit chamber 1 uses the configuration of the above-described embodiment.

First, the raw material to be atomized is charged into the raw material tank 101, and is adjusted to a slurry state. Next, the slurry-like raw material M in the raw material tank 101 is pumped into the pressurized chamber of the pressure intensifier 103 by the liquid supply pump 102. The pumped slurry-like raw material M is pressurized by the pressure intensifier 103. The pressurized slurry-like raw material M is supplied to the slit chamber 1.

The slurry-like raw material M supplied to the slit chamber 1 passes through the flow path inside the water guide nozzle 5 and enters the first and second upstream nozzle water guide portions 6c, 6e of the upstream nozzle 6. Thereafter, the slurry-like raw material M collides with the end face of the downstream nozzle 7, and is reduced in diameter in the atomization flow path 7f by changing the trajectory at a right angle. This results in shear stress and cavitation effects and results in atomization.

The atomized raw material M passes through the downstream nozzle water guide portion 7c, the downstream nozzle enlarged diameter portion 7d, and the load receiving nozzle water guide portion 8c, and is then ejected through the merging port 9. Note that the processing may be repeated not only once but also a plurality of times.

The present invention is not limited to the above-described embodiments, and it is needless to say that the present invention can be appropriately modified without departing from the gist thereof.

### REFERENCE SIGNS LIST

1 Slit chamber
2 First chamber inner member
3 Second chamber inner member
4 Chamber outer member
5 Water guide nozzle
6 Upstream nozzle
7 Downstream nozzle
8 Load receiving nozzle
9 Merging port
10 Tightening adjustment member
100 Atomizing apparatus
101 Raw material tank
102 Liquid supply pump
103 Pressure intensifier

What is claimed is:

1. A slit chamber, comprising:
a water guide nozzle into which raw material is supplied;
an upstream nozzle disposed on a downstream side of the water guide nozzle, the upstream nozzle including a first and a second upstream nozzle water guide portions each having an elongated hole and having enlarged diameter portions at both ends; and
a downstream nozzle disposed on a downstream side of the upstream nozzle, the downstream nozzle having a downstream nozzle water guide portion into which the raw material is supplied.

2. The slit chamber according to claim 1, further comprising:
a first chamber inner member into which the raw material is supplied;
a second chamber inner member disposed outside the water guide nozzle, the upstream nozzle and the downstream nozzle; and
a chamber outer member disposed outside the first chamber inner member and the second chamber inner member.

3. The slit chamber according to claim 2, wherein
the first chamber inner member includes a first chamber inner member slope,
the second chamber inner member includes a second distal end, and
the water guide nozzle includes
a water guide nozzle taper joined to the first chamber inner member slope, and
a water guide nozzle peripheral portion disposed inside the second distal end.

4. The slit chamber according to claim 2, wherein
the first chamber inner member includes a peripheral portion, and
the chamber outer member includes an engagement portion configured to engage with the peripheral portion.

5. The slit chamber according to claim 2, further comprising:
a tightening adjustment member configured to adjust tightening of the first chamber inner member, the second chamber inner member, and the chamber outer member.

6. The slit chamber according to claim 2, wherein
the upstream nozzle includes, in a lower portion, an upstream nozzle flat portion,
the downstream nozzle includes, in a lower portion, a downstream nozzle flat portion, and
the second chamber inner member includes a flat positioning portion inside the second chamber inner member.

7. The slit chamber according to claim 1, wherein
the water guide nozzle includes a projection-shaped water guide nozzle joint formed on a downstream side,
the upstream nozzle includes
a projection-shaped first upstream nozzle joint formed on an upstream side, the first upstream nozzle joint configured to be joined to the water guide nozzle joint, and
a projection-shaped second upstream nozzle joint formed on a downstream side, and
the downstream nozzle includes
a projection-shaped first downstream nozzle joint formed on an upstream side, the first downstream nozzle joint configured to be joined to the second upstream nozzle joint, and
a projection-shaped second downstream nozzle joint formed on a downstream side.

8. The slit chamber according to claim 3, wherein
the first chamber inner member includes a peripheral portion, and
the chamber outer member includes an engagement portion configured to engage with the peripheral portion.

9. The slit chamber according to claim 3, further comprising:
a tightening adjustment member configured to adjust tightening of the first chamber inner member, the second chamber inner member, and the chamber outer member.

10. The slit chamber according to claim 4, further comprising:
a tightening adjustment member configured to adjust tightening of the first chamber inner member, the second chamber inner member, and the chamber outer member.

11. The slit chamber according to claim 3, wherein
the upstream nozzle includes, in a lower portion, an upstream nozzle flat portion,
the downstream nozzle includes, in a lower portion, a downstream nozzle flat portion, and
the second chamber inner member includes a flat positioning portion inside the second chamber inner member.

12. The slit chamber according to claim 4, wherein
the upstream nozzle includes, in a lower portion, an upstream nozzle flat portion,
the downstream nozzle includes, in a lower portion, a downstream nozzle flat portion, and
the second chamber inner member includes a flat positioning portion inside the second chamber inner member.

13. The slit chamber according to claim 5, wherein
the upstream nozzle includes, in a lower portion, an upstream nozzle flat portion,
the downstream nozzle includes, in a lower portion, a downstream nozzle flat portion, and
the second chamber inner member includes a flat positioning portion inside the second chamber inner member.

14. The slit chamber according to claim 2, wherein
the water guide nozzle includes a projection-shaped water guide nozzle joint formed on a downstream side,
the upstream nozzle includes
a projection-shaped first upstream nozzle joint formed on an upstream side, the first upstream nozzle joint configured to be joined to the water guide nozzle joint, and
a projection-shaped second upstream nozzle joint formed on a downstream side, and
the downstream nozzle includes
a projection-shaped first downstream nozzle joint formed on an upstream side, the first downstream nozzle joint configured to be joined to the second upstream nozzle joint, and
a projection-shaped second downstream nozzle joint formed on a downstream side.

15. The slit chamber according to claim 3, wherein
the water guide nozzle includes a projection-shaped water guide nozzle joint formed on a downstream side,
the upstream nozzle includes
a projection-shaped first upstream nozzle joint formed on an upstream side, the first upstream nozzle joint configured to be joined to the water guide nozzle joint, and
a projection-shaped second upstream nozzle joint formed on a downstream side, and
the downstream nozzle includes
a projection-shaped first downstream nozzle joint formed on an upstream side, the first downstream nozzle joint configured to be joined to the second upstream nozzle joint, and
a projection-shaped second downstream nozzle joint formed on a downstream side.

16. The slit chamber according to claim 4, wherein
the water guide nozzle includes a projection-shaped water guide nozzle joint formed on a downstream side,
the upstream nozzle includes
a projection-shaped first upstream nozzle joint formed on an upstream side, the first upstream nozzle joint configured to be joined to the water guide nozzle joint, and
a projection-shaped second upstream nozzle joint formed on a downstream side, and
the downstream nozzle includes
a projection-shaped first downstream nozzle joint formed on an upstream side, the first downstream nozzle joint configured to be joined to the second upstream nozzle joint, and
a projection-shaped second downstream nozzle joint formed on a downstream side.

17. The slit chamber according to claim 5, wherein
the water guide nozzle includes a projection-shaped water guide nozzle joint formed on a downstream side,
the upstream nozzle includes
a projection-shaped first upstream nozzle joint formed on an upstream side, the first upstream nozzle joint configured to be joined to the water guide nozzle joint, and
a projection-shaped second upstream nozzle joint formed on a downstream side, and
the downstream nozzle includes
a projection-shaped first downstream nozzle joint formed on an upstream side, the first downstream nozzle joint configured to be joined to the second upstream nozzle joint, and
a projection-shaped second downstream nozzle joint formed on a downstream side.

18. The slit chamber according to claim 6, wherein
the water guide nozzle includes a projection-shaped water guide nozzle joint formed on a downstream side,
the upstream nozzle includes
a projection-shaped first upstream nozzle joint formed on an upstream side, the first upstream nozzle joint configured to be joined to the water guide nozzle joint, and
a projection-shaped second upstream nozzle joint formed on a downstream side, and
the downstream nozzle includes
a projection-shaped first downstream nozzle joint formed on an upstream side, the first downstream nozzle joint configured to be joined to the second upstream nozzle joint, and
a projection-shaped second downstream nozzle joint formed on a downstream side.

19. An atomizing apparatus, comprising:
a raw material tank configured to store the raw material;
a liquid supply pump configured to pump the raw material from the raw material tank;
a pressure intensifier configured to pressurize the raw material supplied from the liquid supply pump; and
the slit chamber according to claim 1.

20. An atomizing apparatus, comprising:
a raw material tank configured to store the raw material;
a liquid supply pump configured to pump the raw material from the raw material tank;
a pressure intensifier configured to pressurize the raw material supplied from the liquid supply pump; and
the slit chamber according to claim 2.
